(19) United States
(12) Patent Application Publication
(10) Pub. No.: US 2024/0060332 A1
(43) Pub. Date: Feb. 22, 2024

(54) MANAGING SHAPE MEMORY ALLOY ACTUATORS

(71) Applicant: Tesla, Inc., Austin, TX (US)

(72) Inventors: Aneesh Kaliyanda, Fremont, CA (US); Shakeel Theodore, Fremont, CA (US)

(21) Appl. No.: 18/261,017

(22) PCT Filed: Feb. 24, 2022
(86) PCT No.: PCT/US2022/017688

§ 371 Date: Jul. 11, 2023

Related U.S. Application Data
(60) Provisional application No. 63/200,292, filed on Feb. 26, 2021.

(51) Int. Cl. E05B 47/00; E05B 83/30; E05B 83/32

(52) U.S. Cl. CPC E05B 47/0009; E05B 83/30; E05B 83/32

(57) ABSTRACT

Techniques for managing shape memory alloy actuators is described. An example system includes a shape memory alloy (SMA)-actuator configured to cause opening of a compartment included in the vehicle, with the SMA-actuator including a wire formed from an SMA material, and with the wire being configured to be adjusted in position or orientation based on a temperature of the wire. The system further includes a controller, the controller being in communication with one or more sensors, with the sensors being configured to obtain temperature measurements associated with the vehicle. The controller is configured to access a lookup table, with the lookup table mapping temperature measurements to operational parameters, determine operational parameters based on the lookup table, and cause implementation of the operational parameters to cause opening of the compartment, with the operational parameters being associated with adjustment of the temperature of the wire.

### CROSS-REFERENCE TO RELATED APPLICATION

This application claims the benefit of U.S. Provisional Patent Application No. 63/200,292, titled “MANAGING SHAPE MEMORY ALLOY ACTUATORS,” filed Feb. 26, 2021, the disclosure of which is incorporated herein by reference in its entirety and for all purposes.

### BACKGROUND

### Technical Field

The present disclosure relates to a vehicle, and more particularly, to use of a shape memory alloy in a vehicle.

### Description of Related Art

Generally described, a variety of vehicles, such as electric vehicles, combustion engine vehicles, hybrid vehicles, etc., can be configured with various sensors and components to facilitate operation. For example, vehicles can be configured with one or more actuators or controls which can be utilized to provide access to compartments within a vehicle or change a state of a component. As an example, a vehicle can include a compartment which is designed for storage, and which is accessible via a lid or cover. The lid or cover may be associated with a physical, mechanical control, which requires human manipulation to allow access to the compartment. As another example, the lid or cover may be associated with an actuator mechanism which can be controlled in a manner which provides access to the compartment without requiring human manipulation.

### BRIEF DESCRIPTION OF THE DRAWINGS

FIG. 1 is a block diagram of a logical representative of various components, including an example shape memory alloy-actuator (SMA-actuator), which are included in an example vehicle.

FIG. 2 is a flowchart of a process for the determination of operational parameters of the example SMA-actuator.

FIG. 3 represents a basic representation of a mechanism including an SMA wire, power source/controller and pulley.

FIGS. 4-6 are block diagrams illustrative of an example SMA-actuator implementing a rack and pinion implementation in accordance with aspects of the present disclosure.

FIG. 7 illustrates a block diagram of an example vehicle according to the techniques described herein.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

### Introduction

The present disclosure describes techniques for the configuration and management of shape memory alloy (SMA)-based actuators (herein also referred to as SMA-actuators). Specifically, and as an example, the present disclosure describes use of SMA-actuators to cause, or otherwise enable, opening of compartments or other elements in a vehicle. For example, and as described in more detail below, SMA-actuators may be used for opening of a glovebox in a vehicle. As another example, SMA-actuators may be used for opening of a central or center console included in a vehicle (e.g., a compartment positioned between a driver and a passenger of the vehicle), a door release associated with a door of a vehicle, and so on.

An SMA, as an example, is an alloy which can be deformed when within a first temperature range but may return to its pre-deformed shape when heated to a second temperature range. An SMA may be used to form part of an actuator, with the SMA allowing for activation or actuation of the actuator. For example, an SMA may be heated using current (e.g., Joule heating) to cause the SMA to return to a pre-deformed shape. As may be appreciated, the SMA may thus be adjusted in position, orientation, shape, and so on, through sequences of heating, cooling, of the SMA.

With respect to a vehicle, and as will be described, an SMA may be incorporated into a mechanism which is associated with opening of a compartment or other element. For example, one or more wires may be formed from SMA materials. In this example, the one or more wires may be connected to a mechanical component which engages a latching mechanism or pawls. As an example, wire tension, and its associated force, may be in line with the mechanical component. To initiate opening of the compartment, a temperature may be obtained. For example, the temperature may represent a temperature of an internal cabin of the vehicle. As another example, the temperature may represent a combination of internal temperature and external temperature. Based on the temperature, an actuation time, or other operational parameters, may be identified or selected (e.g., based on a lookup table or other data structure, based on a function, and so on). The actuation time may indicate an amount of time that a voltage (e.g., constant voltage) is to be applied to an SMA material (e.g., the above-described one or more wires). For example, a power may be applied to the one or more wires. This application of voltage causes heating of the SMA material via a current (e.g., a variable current). An example technical benefit of use of different actuation times includes ensuring that the SMA material is heated more, or less, depending on the temperature. In this way, a lifespan of the SMA material may be increased.

### Introduction—SMA-Actuators

More specifically, one or more aspects of the present disclosure relate to the management of operational parameters of one or more SMA-based actuators utilized within a vehicle. A control component associated with an SMA-based actuator obtains an input that corresponds to an actuation of the SMA-based actuator, such as receipt of a signal indicative of a user manipulation of a user interface control or receipt of a signal from a processing component. For example, the user interface control may be provided via a user interface presented on a display. An example control component can include a processor, application specific integrated circuit: (ASIC), included in a vehicle. An example user interface control may represent a user input (e.g., a touch of a touch-sensitive display or adjustment of a physical control).

The above-described control component may obtain inputs associated with the operation of the vehicle, such as cabin temperature, ambient temperature, historical actuator activation information, and the like. In accordance with these embodiments, the control component can access or determine operational parameters for one or more SMA-based actuators, such as actuation times (e.g., times to apply a voltage to the SMA-based actuators), power levels, operating times or other operational parameters based on a processed set of inputs. For example, the control component can determine operational parameters as a function of the inputs. The specified operational parameters can be selected with consideration of mitigation or discouraging the generation of unnecessary heat during the operation of the SMA-based actuators to allow for faster recovery of the SMA-based actuators.

Additionally, in some embodiments, the vehicle may be associated with fascia or other coverings which may be susceptible to damage or deformation based on prolonged exposure to additional heat from an SMA-based actuator. Accordingly, the specified operational parameters may be further selected or specified with consideration of mitigation or discouraging of prolonged operation of the SMA-actuator resulting in such damages.

Illustratively, the control component can utilize logic control in the form of a lookup table which maps information from information sources to operational parameters. In some embodiments, the lookup table can indicate respective amounts of time to apply a voltage (e.g., constant voltage) to an SMA-actuator based on temperature associated with the vehicle (e.g., actuation times). In some embodiments, the lookup table can indicate respective measures of current or power to be applied to different SMA-actuators. In some embodiments, the lookup table can map sensor information, such as ambient temperature in a vehicle, to respective measures of current or power to be applied to an SMA-actuator. Optionally, the lookup table can indicate information for different SMA-actuators or for different SMA-actuator materials.

In some embodiments, the lookup table can map individual sensor values/operational status to the operational parameters for an SMA-based actuator. For example, the lookup table can map a sensor value/′operational status which has been determined to be controlling of selection of the operational status. In other embodiments, the lookup table can combine individual sensor values/operational status to determine operational parameters. The sensor values can be specified as absolute values that are mapped in the lookup table, ranges of values, binary indications (e.g., on or off), or non-numeric categories (e.g., high, medium, or low). Still further, the lookup table can incorporate weighting values such that the sensor values/operational status can have greater impact or are otherwise ordered in a manner which causes the impact of specific input information to influence the determined operational parameters.

In some embodiments, the lookup tables utilized by the control component can be specifically configured to individual vehicles. Alternatively, the lookup tables can be common to a set of vehicles, such as by vehicle type, geographic location, user type, and the like. For example, vehicles associated with the northeast region may be configured with a common lookup table while vehicles associated with the south region may be configured with a different, common lookup table. Still further, in other embodiments, a vehicle may be configured with a set of lookup tables that can be applied in accordance with geographic location, user, calendar time, and the like. For example, vehicles may be configured to select different lookup tables during winter months, summer months, and spring months. The lookup tables may be statically configured with the control component, which can be periodically updated. In other embodiments, the lookup tables can be more dynamic in which the frequency of update can facilitated via communication functionality associated with the vehicle.

In some embodiments, a lookup table can be configured in a programmatic implementation. Such programmatic implementations can be in the form of mapping logic, a sequence of decision trees, or similar logic. In other embodiments, the control component may incorporate machine learning implementations that may require more refined operation of the SMA-based actuator or in consideration of operational efficiencies of the SMA-based actuator.

In addition to the above, one or more different aspects of the present disclosure relate to the configuration of an SMA-actuator in accordance with a rack and pinion mechanism. Illustratively, the rack and pinion implementation may include an SMA plate for connecting a wire-based SMA material. The SMA plate may hold a pinion gear configured to rotate based on tension provided by the SMA material. The pinion gear may engage a pawl mechanism which is formed from, or made up of, an inboard pawl and an outboard pawl. The rotation of the pinion gear may cause lateral movement of the inboard pawl and outboard pawl relative to a horizontal axis of the SMA plate. The inboard pawl and outboard pawl may be aided by an inner spring and an outer spring to reset the movement of the pawls.

Although the various aspects will be described in accordance with illustrative embodiments and combination of features, one skilled in the relevant art will appreciate that the examples and combination of features are illustrative in nature and should not be construed as limiting.

Some approaches to vehicle controls utilized actuators relate to solenoid-based actuators that are configured to provide high, instantaneous force upon receipt of a signal. Solenoid-based solutions can be noisy during operation and are relatively heavy components (e.g., 210 grams). Additionally, in the context of mass-produced vehicles, solenoid-based actuators are generally expensive, complex components for the limited functionality, such as opening a cover or a lid.

Generally described, shape memory alloys (SMA) are metal compounds that can transform between different crystal structures to actively displace on command. The most widely used SMA compounds are Nickel-Titanium based that have two effective crystal structures. The first crystal structure relates to a Martensite state, which can be characterized by a lower temperature structure and exhibiting a looser packed crystal structure that enables the SMA to have a stretching property. The second crystal structure relates to an Austenite state, which can be characterized by a higher temp structure and exhibiting a tighter packed crystal structure that enables the SMA to have a pulling property. In operation, SMA materials are typically supplied with current, for example via application of a voltage across the SMA materials (e.g., a voltage applied to the SMA materials), which causes resistivity-based heating. The resistivity-based heating actively induces change in the crystal structure from the Martensite state to the Austenite state. Once the current is removed, the heating source is removed from the SMA material, which will cause the SMA to return to the Martensite state once a cooling threshold has been achieved.

In the context of SMA-based actuators that can be incorporated into vehicles, the above-described cooling threshold can lead to inoperability of the actuator or inefficiencies in the operation of the mechanism incorporating the SMA-based actuator. Additionally, continuous, or prolonged, operation of the SMA-based actuator can cause damage or deformation to the SMA-based actuator or portions of the vehicle surface that are directly adjacent to the SMA-based actuator.

### Block Diagram

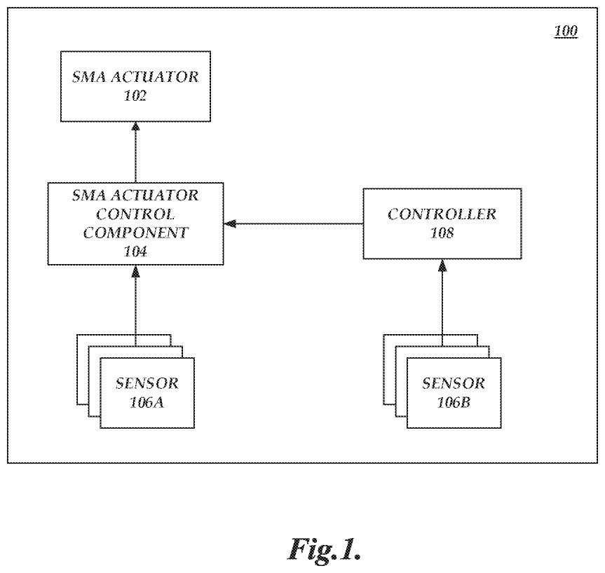

FIG. 1 is a block diagram of a logical representative of various components of a vehicle 100. As illustrated in FIG. 1, the vehicle 100 includes an SMA-actuator 102 for utilization in the operation of the vehicle 100. Although only a single SMA-actuator 102 is illustrated in FIG. 1, a vehicle 100 may incorporate any number of SMA-actuators, each with a defined function and control logic, as will be explained below. Examples of the configuration of the SMA-actuator 102 will be described below in accordance with a glove box actuator mechanism. However, aspects of the present application are not limited to the specific implementation of an actuator for a glovebox and the illustrated examples should not be construed as limiting.

Individual SMA-actuators, such as SMA-actuator 102, may be controlled by one or more control components (e.g., control component 104). The control component 104 may correspond to any microprocessor-based controller, such a programmable logic controller (PLC) or other controller. The control component 104 can include, or enable, logic that facilitates the selection of operational parameters for the SMA-actuator 102. Although illustrated as a stand-alone component, control component 104 may be implemented as functionality of a multi-function controller.

As described above, the sensors 106 can include hardware and software components which can obtain, generate, or process a variety of operational or environmental information sources which are configured in the vehicle 100. In some embodiments, a first subset of sensors 106A can provide raw, collected data to the control component 104 as well as other controls for different functionality. For example, the first subset may provide information via a controller area network (CAN) bus to the control component 104. In other embodiments, one or more controllers 108 may be associated with sensors 106B to process the raw sensor data and provide the processed data as inputs to the control component 104 (e.g., via a CAN bus). By way of illustration, the information provided to control component 104 by the sensors 106, controller components 108 or other processing units can be associated with the operation of the vehicle 100, such as ambient temperature, cabin temperature, humidity, passenger detection, and the like. Thus, in some embodiments, the sensors 106A-106B may obtain, or measure, temperature information (e.g., an ambient temperature of a cabin or interior of the vehicle 100, an external temperature, and so on).

The control component 104 may utilize a collective of information sources that can correspond to pre-existing sensors or components that are already installed in the vehicle 100 and have one or more alternative functions. For example, the control component 104 can utilize a combination of cabin temperature (e.g., multiple cabin temperature measurements from different sensors or a single cabin temperature measurement from a sensor) and external temperature to determine the operational parameters for the SMA-actuator 102. As another example, the control component 104 can utilize a single sensor or temperature reading (e.g., cabin temperature) to determine the operation parameters. For these examples, the operation parameters may allow the SMA-actuator 102 to change crystal structure states, while attempting to mitigate the generation of excessive heat. Other examples and applications may be applied as well.

In another example, the control component 104 can utilize a combination of any of the above-reference information with historical information regarding previous utilization of the SMA-actuator 102. In this example, the control component 104 can either select alternative operational parameters or modify selected operational parameters based on the potential for residual heat from previous use of the SMA-actuator 102. The historical information can be utilized in manner that does not require temperature measurement of the SMA-actuator 102. Accordingly, the selected operational parameters of the SMA-actuator 102 may be different based on the combination of the inputted information.

Illustratively, the control component 104 can utilize a lookup table that can map information from identified sensors to operational parameters of the SMA-actuator 102. In some embodiments, the lookup table can map individual sensor values/operational status to the determine operational parameters for the SMA-actuator 102. In other embodiments, the lookup table can combine individual sensor values/operational status to determine operation parameters. The sensor values can be specified as absolute values that are mapped in the lookup table, ranges of values, binary indications (e.g., on or off), or non-numeric categories (e.g., high, medium, or low). Still further, the lookup table can incorporate weighting values such the sensor values/operational status can have greater impact.

As an example, the control component 104 may obtain a current temperature within a cabin of the vehicle 100 (e.g., an internal temperature). The current temperature may optionally be averaged over a threshold amount of time (e.g., 5 seconds, one minute). Based on the current temperature, one or more operational parameters (e.g., an amount of time to apply a particular voltage to the SMA-actuator, a measure of energy to be applied to the SMA-actuator, or a measure of current or power to be applied to the SMA-actuator 102 for example for a particular amount of time) may be determined. Optionally, the current temperature may be adjusted by an external temperature. For example, the SMA-actuator 102 may be positioned in the vehicle 100 such that the external temperature has an influence on the current temperature of the SMA-actuator 102. In this example, the internal temperature may be adjusted based on the external temperature. As an example, the external temperature may cause the internal temperature to be adjusted upwards or downwards based on an extent to which the external temperature is different from the internal temperature. For this example, and as may be appreciated, an external temperature which is higher than the internal temperature may cause the internal temperature to be adjusted upwards as the temperature affecting the SMA-actuator 102 may be higher than the un-adjusted internal temperature. Similarly, an external temperature which is lower than the internal temperature may cause the internal temperature to be adjusted downwards.

In some embodiments, the lookup table can map a current temperature and an external temperature to one or more operational parameters. The control component 104 may optionally select a closest current cabin temperature and external temperature which is included in the lookup table. In some embodiments, the lookup table may indicate a combination temperature formed from the current cabin temperature and external temperature. For example, each SMA-actuator may be associated with a portion of the lookup table. In this example, the combination temperatures included in this portion may be determined based on an extent to which the SMA-actuator is affected by the cabin temperature and external temperature.

With respect to providing a constant voltage across the SMA-actuator 102 for an amount of time identified or determined based on a lookup table, in some embodiments the constant voltage may cause a current of 0.2 amps, 0.3 amps, 0.8 amps, and so on to flow across the SMA-actuator 102. As an example with respect to the current, if the SMA-actuator 102 is hot (e.g., greater than a first threshold temperature, determined based on internal and/or external temperature) then a lesser amount of current may flow across the SMA-actuator 102 as compared to the SMA-actuator 102 being cold (e.g., less than a second threshold temperature).

With respect to use of a lookup table, in some embodiments the lookup table may allow for determination of operations parameters to increase a lifespan associated with SMA-actuators. For example, the lookup table can allow determination, or selection, of operation parameters which cause the SMA-actuator to increase its temperature until the SMA-actuator is within a temperature range associated with its Austenite structure. Thus, if the vehicle 100 is cold (e.g., the interior) such that the SMA-actuator is cold, then the control component 104 may cause prolonged voltage, and thus prolonged heating due to current, as compared to the SMA-actuator being warmer.

While a lookup table is described above, as may be appreciated additional data structures which map information may be used. Optionally, a function (e.g., a linear or non-linear function) may be used which outputs an amount of time to apply voltage (e.g., constant voltage, such as 1 volt, 2 volts, and so on) based on an input of temperature. For example, the temperature may represent a combination of internal and external temperature. As another example, an internal and an external temperature may be input into the function,

### Flow Chart

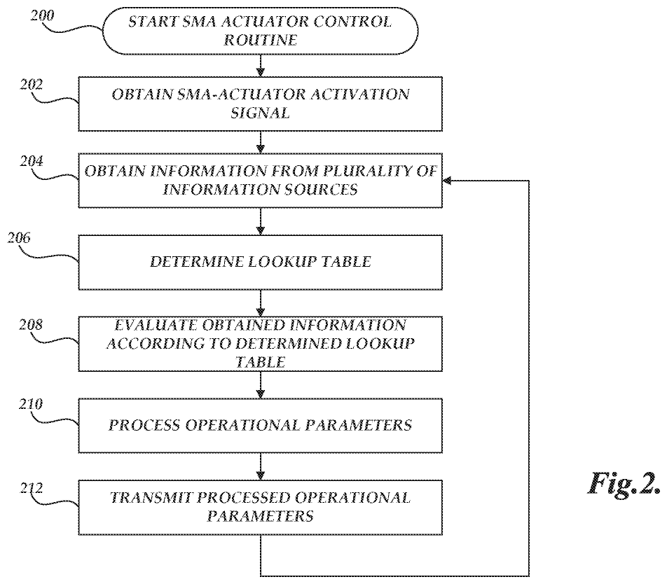

FIG. 2 is a flowchart of an example process 200 for the determination of operational parameters of an example SMA-actuator (e.g., SMA-actuator 102), Process 200 may be implemented for each individual SMA-actuator 102, such as by a control component 104 configured to determine operational parameters for individual SMA-actuator 102 and generate control signals corresponding to the determined operational parameters. Alternatively, process 200 may be implemented for a set of SMA-actuators 102 located on a vehicle or set of vehicles 100.

At block 202, the control component 104 obtains an activation signal for an identified SMA-actuator 102. Illustratively, the activation signal can be generated from a variety of components and corresponding to different events or criteria. In one example, a user in a vehicle (e.g., a driver or passenger) may manipulate a user interface in the vehicle that is correlated to an activation of the SMA-actuator 102, such as a user interface-based control to cause a glove box or center console to “open.” In another example, a user may manipulate an additional device, such as a remote control or mobile device that causes a transmission of information to the vehicle 100 and the control component 104.

In other examples, some processing components, such as a logic unit, may assess vehicle operation or passenger interaction to cause the generation of the signal. For example, a vision system may detect user physical attention to a component that may be interpreted as an instruction. Similarly, an audio system may interpret audible commands to cause components to open, Still further, the logic units can also cause the transmission of the signal based on operational status of the vehicle, such as speed, transmission state, operational state of windshield wipers, and the like, that can be associated with a desire or need to cause the operation of the SMA-actuator 102.

At block 204, the control component 104 obtains a set of information sources, such as from a plurality of sensors 106, controllers 108, and the like. Optionally, the control component 104 may obtain information from an individual sensor (e.g., an internal cabin temperature sensor). The information sources may be continuously provided to the control component 104 by individual sensors/controllers or upon a set schedule. Alternatively, the control component 104 may periodically poll sensors/controller for inputs based on deterministic criteria, such as the satisfaction of thresholds (e.g., minimum temperature settings). In some embodiments, the sensors 106 can provide raw, collected data to the control component 104 as well as other controls for different functionality. In other embodiments, the controllers 108 may be associated with sensors 106 and process the raw sensor data and provide the processed data as inputs to the control component 104.

At block 206, the control component 104 determines an appropriate lookup table or accesses a lookup table. In some embodiments, one or more lookup tables utilized by the control component 104 can be specifically configured to individual vehicles. Alternatively, the lookup tables can be common to a set of vehicles, such as by vehicle type, geographic location, user type, and the like. For example, vehicles associated with the northeast region may be configured with a common table while vehicles associated with the south region may be configured with a different, common table. Still further, in other embodiments, a vehicle 100 may be configured with a set of tables that can be applied in accordance with geographic location, user, calendar time, and the like. For example, vehicles may be configured or select different lookup tables during winter months than in summer months or spring months. The lookup tables may be statically configured with the control component, which can be periodically updated. In other embodiments, the lookup tables can be more dynamic in which the frequency of update can facilitated via communication functionality associated with the vehicle. If multiple lookup tables are not provided or the control component is not otherwise configured to process selection criteria, a single lookup table can be automatically retrieved as part of the block 206.

At block 208, the control component 104 evaluates the sensor inputs to identify one or more operational parameters which may form candidate operational parameters. In some embodiments, the evaluation of the lookup table may be deterministic such that only a single operational parameter may result from evaluation of the lookup table. In other embodiments, the evaluation of the lookup table may be non-deterministic such that two or more different operational parameters (e.g., conflicting times, conflicting power levels, etc.) may result from evaluation of the lookup table. As previously described, the operational parameters can include times to apply a voltage, power level, current levels, operational times, power sources, and the like.

At block 210, the control component 104 can optionally process the identified operational parameters to conduct error checking, threshold comparison, conflict resolutions, normalization, and the like. For example, the control component 104 may choose to select the lowest operational parameter if more than one operational parameter results from the lookup table evaluation. In another example, the control component 104 may choose to average operational values or other statistical processing of operational parameters. For example, the control component logic can include historical information that can track operation of the SMA-actuator 102 for a period of time. Evaluation of the lookup table based on ambient temperature may indicate that the SMA-actuator 102 should typically operate for a fixed period of time. In this embodiment, however, the further processing of the operational parameter may consider that the previous operation of the SMA-actuator 102 has likely resulted in some residual heat in the SMA-actuator 102 or other components. Accordingly, in some embodiments, in may be possible the operational parameters selected by the control component 104 may be different based on the same (or substantially similar) input parameters.

At block 212, the control component 104 transmits information or control signals that causes the operation of the SMA-actuator 102 in accordance with the selected and processed operational parameters, including the omission of the transmission of control signals. For example, the control component 104 may cause initiation of power to a power cable of the SMA-actuator. The power may be applied according to the operational parameters. For example, a voltage may be applied for a particular amount of time such that current (e.g., varying current) flows across the SMA-actuator for the particular amount of time. Without being constrained by way of example, the control component 104 may cause power or current to be initiated via a microcontroller associated with controlling power. In some embodiments, the control component 104 may be connected to a power source and cause a voltage to be applied to the SMA-actuator 102. Process 200 returns to block 202 in embodiments for continuous monitoring or can wait for institution of the process 200.

### Example Embodiments

As previously described, one or more different aspects of the present disclosure relate to the configuration of the SMA-actuator 102 in accordance with a control mechanism for utilization in combination with a glove box, center console, or other similar component/compartment. In one illustrative embodiment, the SMA-actuator 102 corresponds to an SMA in wire form that is implemented in a manner such that wire tension, and its associated force, is in line with the mechanical component that engages a latching mechanism or pawls.

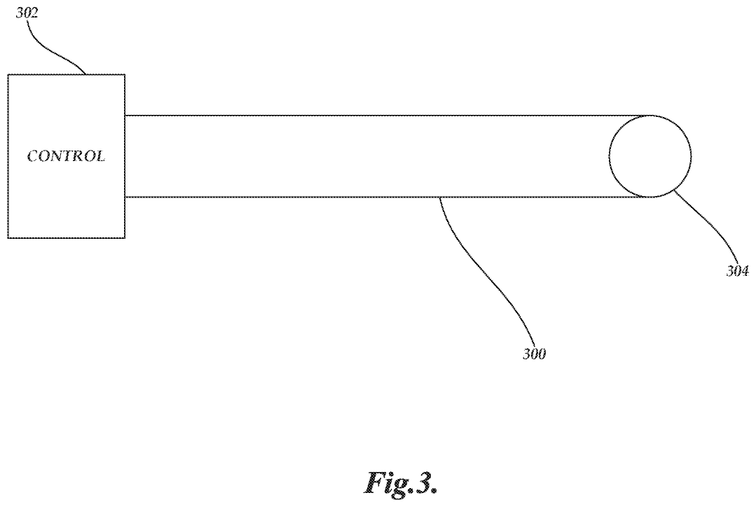

FIG. 3 represents a basic representation of such a mechanism including an SMA wire 300, power source/controller 302 and pulley 304. The utilization of a pulley 304 allows for a multiplication of the tension force and packaging of the SMA-actuator 102. The SMA wire 300 can be a variety of lengths such as in the range of 450 mm to 600 mm, including 455, 460, 465, 470, 475, 480, 485, 490, 495, 500, 505, 510, 515, 520, 525, 530, 535, 540, 545, 550, 555, 560, 565, 570, 575, 580, 585, 590, 595 and dimension in between. Illustratively, the SMA wire 300 can further be of a thickness in the range of 0.005 to 0.15, including 0.005, 0.006, 0.007, 0.008, 0.009, 0.010, 0.011, 0.012, 0.013, 0.014, and value in between. It should be recognized that these values are illustrative and do not represent the full range of possible values for the dimensions of the SMA wire. Still further, in other embodiments the SMA material can be in the form of springs, coils, links and custom solids.

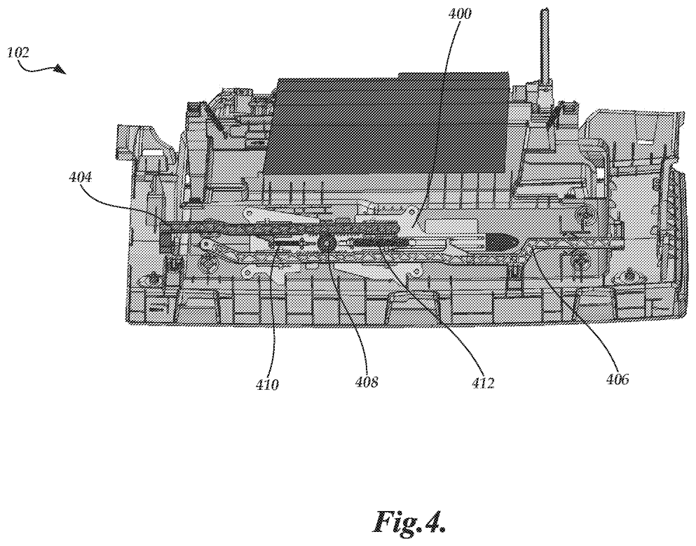

FIGS. 4-6 are block diagrams illustrative of an SMA-actuator 102 implementing a rack and pinion implementation in accordance with aspects of the present application.

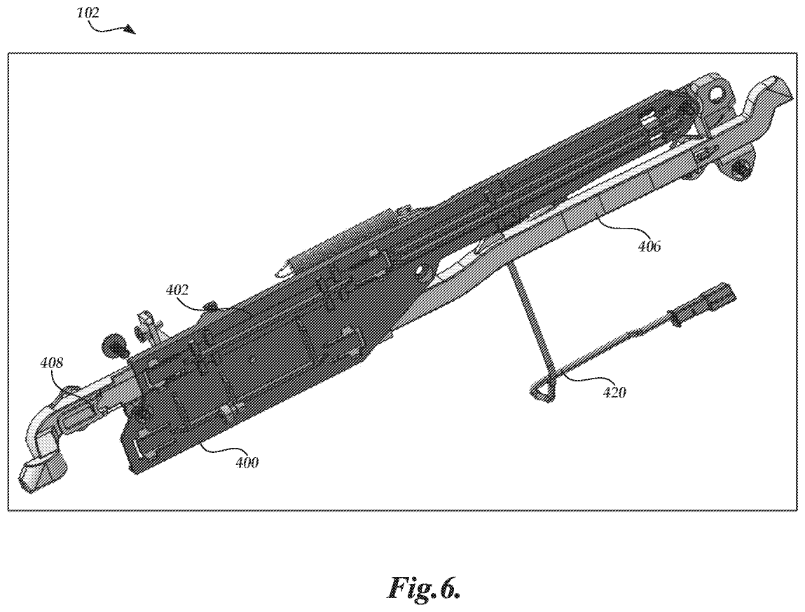

As illustrated in FIG. 4, the SMA-actuator 102 includes an SMA plate 400 for connecting the SMA material (not shown). The SMA plate 400 holds a pinion gear 408 that will rotate based on tension provided by the SMA material (e.g., wire 402 illustrated in FIG. 6). As an example, the wire may cause rotation based on the SMA material (e.g., wire) being heated from the martensite state to the austenite state. For example, the wire may be changed in shape or orientation such that tension is provided. As discussed in FIG. 3, the tension can be further increased through the utilization of a pulley, modifications to the properties of the springs 410, 412 and the like. The pinion gear 408 engages a pawl mechanism which is formed from an inboard pawl 404 and an outboard pawl 406. The rotation of the pinion gear 408 causes lateral movement of the inboard pawl 404 and outboard pawl 406 relative to a horizontal axis of the SMA plate 400. The inboard pawl 404 and outboard pawl 406 are aided by inner spring 410 and outer spring 412 to reset the movement of the pawls.

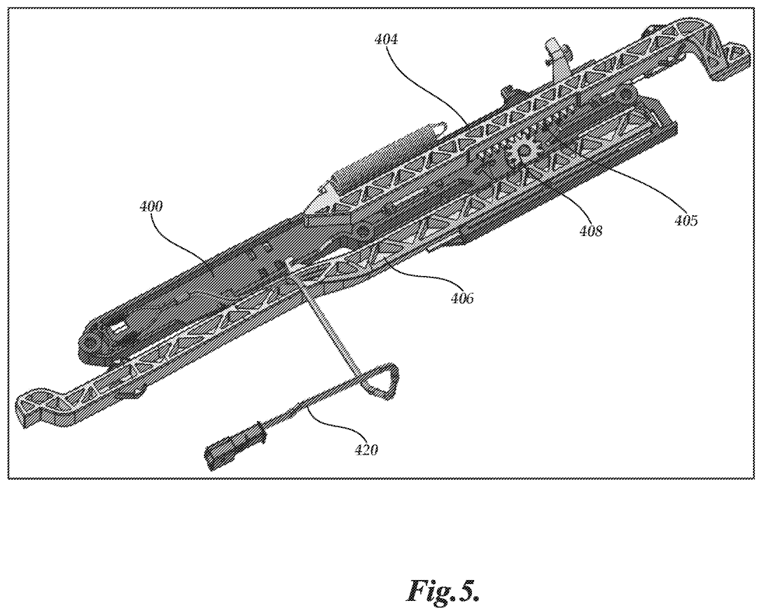

FIG. 5 illustrates the SMA-actuator 102 described in FIG. 4, and further illustrates the power cable 420 for providing the control signal to an SMA wire (e.g., wire 402 illustrated in FIG. 6). FIG. 5 also illustrates teeth 405 on the inboard pawl 404 for engaging the pinion gear 408. The outboard pawl 406 would also include similar teeth (not shown).

FIG. 6 illustrates the oppositive face of the SMA plate 400 including the SMA wire 402.

### Example Vehicle

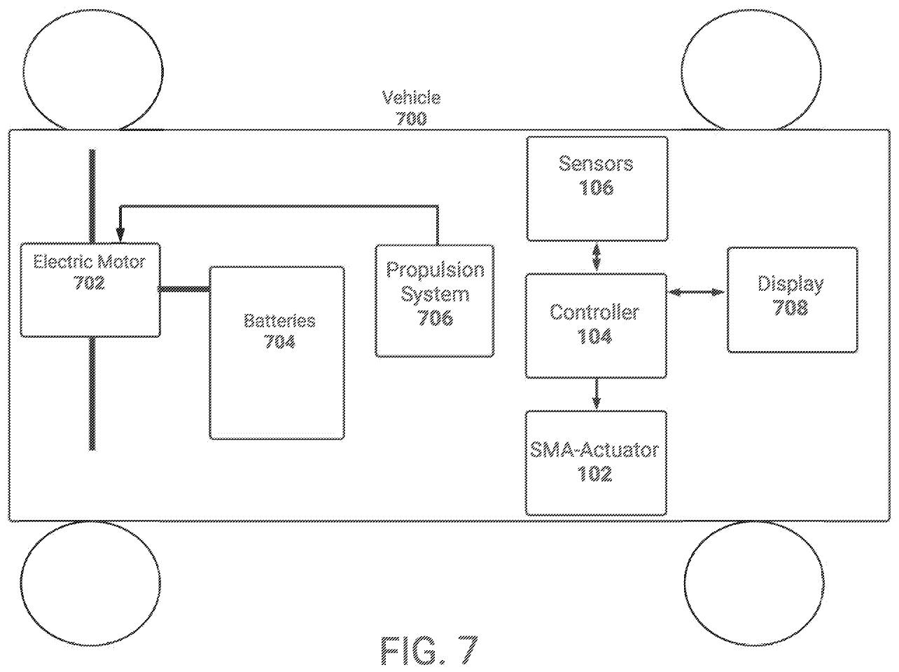

FIG. 7 illustrates a block diagram of a vehicle 700 (e.g., vehicle 100). The vehicle 700 may include one or more electric motors 702 which cause movement of the vehicle 700. The electric motors 702 may include, for example, induction motors, permanent magnet motors, and so on. Batteries 704 (e.g., one or more battery packs each comprising a multitude of batteries) may be used to power the electric motors 702 as is known by those skilled in the art.

The vehicle 700 further includes a propulsion system 706 usable to set a gear (e.g., a propulsion direction) for the vehicle. With respect to an electric vehicle, the propulsion system 706 may adjust operation of the electric motor 702 to change propulsion direction.

Additionally, the vehicle includes the controller 104 as described herein. The controller 104, as described above, may cause the SMA-actuator 102 to open a compartment (e.g., a glovebox) based on information from one or more sensors(s) 106. For example, the controller 104 may obtain temperature measurements (e.g., internal measurements, external measurements) from a controller area network (CAN) bus of the vehicle 700 in communication with the sensors 106 or associated controller(s) 108. Based on the temperature measurements, for example using a data structure (e.g., a lookup table) or based on a function (e.g., linear or nonlinear function), the controller 104 may identify an actuation time (e.g., a time to apply constant voltage across the SMA-actuator 102) or a particular measure of current or power to be applied to the SMA-actuator 102 (e.g., for a particular amount of time).

In some embodiments, a user (e.g., a passenger or driver) may use the display 708 (e.g., touch-sensitive display) to provide user input indicative of opening the compartment. In response to the user input, the controller 104 may receive information indicating the user request and may cause opening of the compartment via the SMA-actuator 102.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, a person of ordinary skill in the art will recognize that changes may be made in form and detail without departing from the scope of the present disclosure. Thus, the present disclosure is limited only by the claims.

In the foregoing specification, the disclosure has been described with reference to specific embodiments. However, as one skilled in the art will appreciate, various embodiments disclosed herein can be modified or otherwise implemented in various other ways without departing from the spirit and scope of the disclosure. Accordingly, this description is to be considered as illustrative and is for the purpose of teaching those skilled in the art the manner of making and using various embodiments of the disclosed glove box actuation assembly. It is to be understood that the forms of disclosure herein shown and described are to be taken as representative embodiments. Equivalent elements, materials, processes or steps may be substituted for those representatively illustrated and described herein. Moreover, certain features of the disclosure may be utilized independently of the use of other features, all as would be apparent to one skilled in the art after having the benefit of this description of the disclosure. Expressions such as “including”, “comprising”, “incorporating”, “consisting of”, “have”, “is” used to describe and claim the present disclosure are intended to be construed in a non-exclusive manner, namely allowing for items, components or elements not explicitly described also to be present. Reference to the singular is also to be construed to relate to the plural.

Further, various embodiments disclosed herein are to be taken in the illustrative and explanatory sense, and should in no way be construed as limiting of the present disclosure. All joinder references (e.g., attached, affixed, coupled, connected, and the like) are only used to aid the reader's understanding of the present disclosure, and may not create limitations, particularly as to the position, orientation, or use of the systems and/or methods disclosed herein. Therefore, joinder references, if any, are to be construed broadly. Moreover, such joinder references do not necessarily infer that two elements are directly connected to each other.

Additionally, all numerical terms, such as, but not limited to, “first”, “second”, “third”, “primary”, “secondary”, “main” or any other ordinary and/or numerical terms, should also be taken only as identifiers, to assist the reader's understanding of the various elements, embodiments, variations and/or modifications of the present disclosure, and may not create any limitations, particularly as to the order, or preference, of any element, embodiment, variation and/or modification relative to, or over, another element, embodiment, variation and/or modification.

It will also be appreciated that one or more of the elements depicted in the drawings/figures can also be implemented in a more separated or integrated manner, or even removed or rendered as inoperable in certain cases, as is useful in accordance with a particular application

What is claimed:

1. A system configured for inclusion in a vehicle, the system comprising:
a shape memory alloy (SMA)-actuator configured to cause opening of a compartment included in the vehicle, wherein the SMA-actuator includes a wire formed from an SMA material, and wherein the wire is configured to be adjusted in position or orientation based on a temperature of the wire; and
a controller, the controller being in communication with one or more sensors, wherein the sensors are configured to obtain temperature measurements associated with the vehicle, and wherein the controller is configured to:
access a lookup table, wherein the lookup table maps temperature measurements to operational parameters;
determine operational parameters based on the lookup table; and
cause implementation of the operational parameters to cause opening of the compartment, wherein the operational parameters are associated with adjustment of the temperature of the wire.

2. The system of claim 1, wherein the SMA-actuator is a rack and pinion mechanism.

3. The system of claim 1, wherein the compartment is a glovebox of the vehicle.

4. The system of claim 1, wherein the compartment is a center console of the vehicle.

5. The system of claim 1, wherein the wire is connected to a pulley, and wherein the pulley enables a multiplication of tension associated with the wire.

6. The system of claim 1, wherein the wire is in line with a latching mechanism of the component.

7. The system of claim 1, wherein the operational parameters include an amount of time to apply a voltage across the wire, and wherein the controller causes application of the voltage such that current causes heating of the wire.

8. The system of claim 1, wherein the controller accesses the lookup table from a plurality of lookup tables, and wherein individual lookup tables of the plurality of lookup tables are associated with respective geographic regions.

9. The system of claim 1, wherein the lookup table maps temperature information associated with an internal temperature of the vehicle and an external temperature.

10. The system of claim 1, wherein the controller causes implementation of the operational parameters via initiation of voltage or power into a power cable of the SMA-actuator.

11. A vehicle comprising:
one or more sensors positioned on the vehicle;
a shape memory alloy (SMA)-actuator configured to cause opening of a compartment included in the vehicle, wherein the SMA-actuator includes a wire formed from an SMA material, and wherein the wire is configured to be adjusted in position or orientation based on a temperature of the wire; and
a controller, the controller being in communication with the one or more sensors, wherein the sensors are configured to obtain temperature measurements associated with the vehicle, and wherein the controller is configured to:
access a lookup table, wherein the lookup table maps temperature measurements to operational parameters;
determine operational parameters based on the lookup table; and
cause implementation of the operational parameters to cause opening of the compartment, wherein the operational parameters are associated with adjustment of the temperature of the wire.

12. The vehicle of claim 11, wherein the SMA-actuator is a rack and pinion mechanism.

13. The vehicle of claim 11, wherein the compartment is a glovebox of the vehicle.

14. The vehicle of claim 11, wherein the compartment is a center console of the vehicle.

15. The vehicle of claim 11, wherein the wire is in line with a latching mechanism of the component.

16. The vehicle of claim 11, wherein the one or more sensors include a first sensor configured to measure temperature within the vehicle and a second sensor configured to measure temperature external to the vehicle.

17. The vehicle of claim 11, wherein the lookup table maps temperature information associated with an internal temperature of the vehicle and an external temperature.

18. The vehicle of claim 11, wherein the controller is configured to access the lookup table based on receipt of user input associated with opening the compartment, wherein the user input is received via a display of the vehicle.

19. A method implemented via a controller included in a vehicle, wherein the controller is configured to cause opening of a compartment of the vehicle via a shape memory alloy (SMA)-actuator, and wherein the method comprises:
obtaining information reflecting user input associated with opening of the compartment;
obtaining sensor information from one or more sensors positioned about the vehicle, the sensor information reflecting, at least, temperature information associated with the vehicle;
determining operational parameters based on one or more data structures, wherein the data structures map temperature information to operational parameters, and wherein the operational parameters are associated with adjustment of the temperature of a SMA element included in the SMA-actuator; and
causing implementation of the operational parameters, such that the temperature of the SMA element is increased.

20. The method of claim 19, wherein the operational parameters include an amount of time to apply a voltage across the wire, and wherein the controller causes application of the voltage such that current causes heating of the wire.
